(19) United States
(12) Patent Application Publication
(10) Pub. No.: US 2014/0278427 A1
(43) Pub. Date: Sep. 18, 2014

(54) DYNAMIC DIALOG SYSTEM AGENT INTEGRATION

(71) Applicant: SAMSUNG ELECTRONICS CO., LTD., Suwan (KR)

(72) Inventors: Christopher M. Riviere Escobedo, Tustin, CA (US); Chun Shing Cheung, Irvine, CA (US)

(21) Appl. No.: 13/802,448

(22) Filed: Mar. 13, 2013

(51) Int. Cl. G10L 15/18

(52) U.S. Cl. CPC G10L 15/18
USPC 704/257; 704/231

(57) ABSTRACT

A method for dialog agent integration comprises discovering a dialog agent required for a dialog request including dialog information comprising terms required for audio feedback in a service domain required for the dialog request, extracting the dialog information from the discovered dialog agent, integrating the dialog information to existing dialog information of a dialog system (DS) that provides dialog functionality for an electronic device, and expanding the service domain dialog functionality of the DS with the integrated dialog information.

### TECHNICAL FIELD

One or more embodiments relate generally to dialog systems and, in particular, to extending dialog systems by integration of third-party agents.

### BACKGROUND

Automatic Speech Recognition (ASR) is used to convert uttered speech to a sequence of words. ASR is used for user purposes, such as dictation. Typical ASR systems convert speech to words in a single pass with a generic set of vocabulary (words that the ASR engine can recognize). Dialog systems use recognized speech to figure out what a user is asking the system to do. A dialog system provides audio feedback to a user in the form of a system response using text-to-speech (TTS) technology. Dialog applications from providers are provider or service-domain specific (e.g., hotel booking) and are independent of devices on which the dialog application may be installed. In order to switch service domains, a user must launch another separate dialog application.

### SUMMARY

In one embodiment, a method provides dialog agent integration. One embodiment comprises a method that comprises discovering a dialog agent required for a dialog request, the dialog agent including dialog information comprising terms required for audio feedback in a service domain required for the dialog request. In one embodiment, the dialog information is extracted from the discovered dialog agent. In one embodiment, the dialog information is integrated to existing dialog information of a dialog system (DS) that provides dialog functionality for an electronic device. In one embodiment, service-domain dialog functionality of the DS is expanded with the integrated dialog information.

One embodiment provides a system for dialog agent integration. In one embodiment, an electronic device includes a microphone for receiving speech signals and an automatic speech recognition (ASR) engine that converts the speech signals into words. In one embodiment, a dialog system (DS) receives the words from the ASR engine and provides dialog functionality for the electronic device. In one embodiment, the dialog system comprises a DS agent interface that integrates dialog information from a dialog agent to existing dialog information of the DS for expanding dialog functionality of the DS.

Another embodiment provides a non-transitory computer-readable medium having instructions which when executed on a computer perform a method comprising: discovering a dialog agent required for a dialog request, the dialog agent including dialog information comprising terms required for audio feedback in a service domain required for the dialog request. In one embodiment, the dialog information is extracted from the discovered dialog agent. In one embodiment, the dialog information is integrated to existing dialog information of a dialog system (DS) that provides dialog functionality for an electronic device. In one embodiment, service-domain dialog functionality of the DS is expanded with the integrated dialog information.

These and other aspects and advantages of the embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of an architecture system for dialog agent integration for an electronic device, according to an embodiment.

FIG. 3 shows an example flow chart for dialog agent integration for an electronic device, according to an embodiment.

FIG. 4 shows an example flow chart for dialog agent integration for an electronic device, according to an embodiment.

FIG. 5 shows an example dialog agent natural language understanding (NLU) information for dialog agent integration for an electronic device, according to an embodiment.

FIG. 6 shows an example dialog agent NLU information shown in picture form for dialog agent integration for an electronic device, according to an embodiment.

FIG. 7 shows an example dialog agent structure for a dialog manager (DM) information for dialog agent integration for an electronic device, according to an embodiment.

FIG. 8 shows an example existing dialog agent structure for dialog agent integration for an electronic device, according to an embodiment.

FIG. 9 shows an example of an expanded NLU for an integrated dialog agent for an electronic device, according to an embodiment.

FIG. 10 shows an example of an expanded NLU in picture form for an integrated dialog agent for an electronic device, according to an embodiment.

FIG. 11 shows an example expanded DM structure for an integrated dialog agent for an electronic device, according to an embodiment

FIG. 12 is a high-level block diagram showing an information processing system comprising a computing system implementing an embodiment.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to dialog agent (e.g., third-party agent) expansion for a dialog system (DS). One embodiment provides dialog agent information integration for third-party dialog agents into a DS of an electronic device.

In one embodiment, the electronic device comprises a mobile electronic device capable of data communication over a communication link such as a wireless communication link. Examples of such mobile device include a mobile phone device, a mobile tablet device, etc. Examples of stationary devices include televisions, projector systems, etc. In one embodiment, a method provides dialog agent integration for an electronic device. One embodiment comprises discovering a desired dialog agent required for a dialog request, the dialog agent including dialog information comprising terms required for audio feedback in a service domain. In one embodiment, the dialog information is extracted from the discovered dialog agent. In one embodiment, the dialog information is integrated to existing dialog information of a dialog system (DS) that provides dialog functionality for an electronic device. In one embodiment, service-domain dialog functionality of the DS is expanded with the integrated dialog information.

In one embodiment, examples of dialog agents (e.g., third-party dialog agents) may comprise dialog agents for service domains, such as booking services (e.g., hotel/motel, travel, etc.), reservation services (e.g., car rental, flights, restaurant, etc.), ordering services (e.g., food delivery, products, etc.), appointment services (e.g., medical appointments, social appointments, business appointments, etc.), etc. In one embodiment, the dialog agent comprises response and grammatical information for the associated particular service domain. Third-party dialog agent information may comprise special vocabularies/grammar/responses and may be very dynamic. One embodiment provides an electronic device, a DS that may dynamically expand in features by integrating additional dialog agents.

One embodiment provides for creating an extensible DS that includes multiple dialog-specific functionalities and provides for integrating new dialog agents for expanded service domains with the DS. In one embodiment, an agent may be either included as part of a speech application itself or provided as a separate module. In one example, a ‘Hotel Booking’ dialog speech application may include a ‘Hotel Booking’ agent that allows the DS to understand user utterances that relate to hotel reservations. In one embodiment, new functionality is added into a DS by integrating third-party dialog agents that are able to handle the user's utterances for the dialog agent's specific service domain. In one embodiment, the dialog agents may be generated by applying system-specific toolkits that are dependent on the DS architecture. These toolkits allow a third party to provide a dialog agent that implements the minimum functionality required to integrate with the DS. In one example, a ‘Simple Hotel Booking’ dialog agent may include the natural language understanding (NLU) grammar that generates the language that this dialog agent can understand. In order to control the flow of the dialog specific to hotel booking, this dialog agent includes a dialog manager (DM) that may be used to obtain input from the user. In one embodiment, a dialog agent provides a list of system responses relevant to the dialog agent's service domain. In one embodiment, the responses may be automatically generated using natural language generation (NLG) information or module.

FIG. 1 is a schematic view of a communications system in accordance with one embodiment. Communications system 10 may include a communications device that initiates an outgoing communications operation (transmitting device 12) and communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include several transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Transmitting device 12 and receiving device 11, when located within communications network 110, may communicate over a bidirectional communication path such as path 13. Both transmitting device 12 and receiving device 11 may be capable of initiating a communications operation and receiving an initiated communications operation.

Transmitting device 12 and receiving device 11 may include any suitable device for sending and receiving communications operations. For example, transmitting device 12 and receiving device 11 may include a media player, a cellular telephone or a landline telephone, a personal e-mail or messaging device with audio and/or video capabilities, pocket-sized personal computers such as an iPAQ Pocket PC available by Hewlett Packard Inc., of Palo Alto, Calif., personal digital assistants (PDAs), a desktop computer, a laptop computer, and any other device capable of communicating wirelessly (with or without the aid of a wireless enabling accessory system) or via wired pathways (e.g., using traditional telephone wires). The communications operations may include any suitable form of communications, including for example, voice communications (e.g., telephone calls), data communications (e.g., e-mails, text messages, media messages), or combinations of these (e.g., video conferences).

FIG. 2 shows a functional block diagram of an architecture system 100 that may be used for dialog agent integration for an electronic device 120, according to an embodiment. Both transmitting device 12 and receiving device 11 may include some or all of the features of electronics device 120. In one embodiment, the electronic device 120 may comprise a display 121, a microphone 122, audio output 123, input mechanism 124, communications circuitry 125, control circuitry 126, a camera 127, a global positioning system (GPS) receiver module 118, an ASR engine 135 and a DS 140, and any other suitable components. In one embodiment, dialog agent 1 147 to dialog agent N 160 are provided by third-party providers and may be obtained from the cloud or network 130, where N is a positive integer equal to or greater than 1, communications network 110, etc.

In one embodiment, all of the applications employed by audio output 123, display 121, input mechanism 124, communications circuitry 125 and microphone 122 may be interconnected and managed by control circuitry 126. In one example, a hand held music player capable of transmitting music to other tuning devices may be incorporated into the electronics device 120.

In one embodiment, audio output 123 may include any suitable audio component for providing audio to the user of electronics device 120. For example, audio output 123 may include one or more speakers (e.g., mono or stereo speakers) built into electronics device 120. In some embodiments, audio output 123 may include an audio component that is remotely coupled to electronics device 120. For example, audio output 123 may include a headset, headphones or earbuds that may be coupled to communications device with a wire (e.g., coupled to electronics device 120 with a jack) or wirelessly (e.g., Bluetooth® headphones or a Bluetooth® headset).

In one embodiment, display 121 may include any suitable screen or projection system for providing a display visible to the user. For example, display 121 may include a screen (e.g., an LCD screen) that is incorporated in electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen. The input mechanism may include a user interface that may emulate a rotary phone or a multi-button keypad, which may be implemented on a touch screen or the combination of a click wheel or other user input device and a screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an ASR application, a dialog application, a map application, a media application (e.g., QuickTime, MobileMusic.app, or MobileVideo.app). In some embodiments, the electronics device 120 may include one or several applications operative to perform communications operations. For example, the electronics device 120 may include a messaging application, a mail application, a telephone application, a voicemail application, an instant messaging application (e.g., for chatting), a videoconferencing application, a fax application, or any other suitable application for performing any suitable communications operation.

In some embodiments, the electronics device 120 may include microphone 122. For example, electronics device 120 may include microphone 122 to allow the user to transmit audio (e.g., voice audio) during a communications operation or as a means of establishing a communications operation or as an alternate to using a physical user interface. Microphone 122 may be incorporated in electronics device 120, or may be remotely coupled to the electronics device 120. For example, microphone 122 may be incorporated in wired headphones, or microphone 122 may be incorporated in a wireless headset.

In one embodiment, the electronics device 120 may include any other component suitable for performing a communications operation. For example, the electronics device 120 may include a power supply, ports or interfaces for coupling to a host device, a secondary input mechanism (e.g., an ON/OFF switch), or any other suitable component.

In one embodiment, a user may direct electronics device 120 to perform a communications operation using any suitable approach. As one example, a user may receive a communications request from another device (e.g., an incoming telephone call, an email or text message, an instant message), and may initiate a communications operation by accepting the communications request. As another example, the user may initiate a communications operation by identifying another communications device and transmitting a request to initiate a communications operation (e.g., dialing a telephone number, sending an email, typing a text message, or selecting a chat screen name and sending a chat request).

In one embodiment, the electronic device 120 may comprise a mobile device that may utilize mobile device hardware functionality including: the display 121, the GPS receiver module 132, the camera 131, a compass module, and an accelerometer and gyroscope module. The GPS receiver module 132 may be used to identify a current location of the mobile device (i.e., user). The compass module is used to identify direction of the mobile device. The accelerometer and gyroscope module is used to identify tilt of the mobile device. In other embodiments, the electronic device may comprise a television or television component system.

In one embodiment, the ASR engine 135 provides speech recognition by converting speech signals entered through the microphone 122 into words based on the vocabulary applications. In one embodiment, the dialog agent 1 147 to dialog agent N 160 may comprise grammar and response language that requires specific vocabulary applications in order for the ASR engine 135 to provide correct speech recognition. In one embodiment, the electronic device 120 uses an ASR 135 that provides for speech recognition integration of third-party vocabulary applications for providing speech recognition results. In one embodiment, the third-party vocabulary application may be provided by a same provider of a specific service-domain dialog agent. In one embodiment, a third-party vocabulary application may comprise the specific service-domain dialog agent.

It may be difficult, however, to initiate a communications operation with a recipient and to execute a dialog session during the communications operation. For example, a user may place a phone call to a friend and may wish to make reservations or book a flight for the two of them. The user may have to terminate the phone call in order to communicate with a third-party dialog service using the same communications device. To avoid such situations, the embodiments may allow the user to initiate or accept a communications operation and, once the communications operation is established, to also execute a dialog session during the communications operation using the same communications device.

In one embodiment, the DS 140 comprises a DS agent interface 129, NLU module 141, NLG module 142, DM module 143 and TTS engine 144. In one embodiment, the NLU module 141 comprises one or more files that include NLU information, such as grammatical connected language ordered in a particular notation. In one embodiment, the NLU information file(s) includes context-free grammar (CFG) text provided in a particular notation, such as using the Extended Backus-Naur Form (EBNF) notation. In one embodiment, the NLU module 141 includes a CFG parser that detects an utterance based on locating a production rule for a respective dialog agent. In one embodiment, each production rule is associated with a probabilistic CFG (PCFG), where a probability of each possible parse is used for identifying a most likely interpretation of speech input to the DS 140 from the ASR engine 135.

In one embodiment, the NLG module 142 comprises one or more files that include NLG information, such as entries or a list of possible provider feedback responses associated with supported actions to reply to speech utterances entered through the microphone 122. In one embodiment, the DM module 143 includes DM information comprising one or more files including an ordered structure of related actions and responses for progressing through a dialog conversation once selected for execution. In one embodiment, the ordered structure of the DM information comprises a dialog tree including nodes representing user-requested actions and branches connected to the nodes representing speech responses.

In one embodiment, the dialog agent 1 147 includes NLU information 148, NLG information 149 and DM information 150, and dialog agent N 160 includes NLU information 161, NLG information 162, and DM information 163. In one embodiment, integrating the dialog information (i.e., NLU 148, NLG 149 and DM 150) from the dialog agent 1 147 to the existing dialog information (i.e., NLU, NLG and DM files of the DS 140) comprises adding the NLU information 148 from the dialog agent 1 147 to the NLU information of the NLU module 141, adding the NLG information 149 from the dialog agent 1 147 to the NLG information of the NLG module 142; and adding the DM information 150 from the dialog agent 1 147 to the DM information of the DM module 143. In one embodiment, the dialog information from the dialog agent 1 147 is merged/appended with the existing dialog information of the DS 140.

In one embodiment, integrating the dialog information (i.e., NLU 161, NLG 162, and DM 163) from the dialog agent N 160 to the existing dialog information (i.e., NLU, NLG, and DM files of the DS 140) comprises adding the NLU information 161 from the dialog agent N 160 to the NLU information of the NLU module 141, adding the NLG information 162 from the dialog agent N 160 to the NLG information of the NLG module 142; and adding the DM information 163 from the dialog agent N 160 to the DM information of the DM module 143. In one embodiment, after the dialog information of the dialog agent 1 147 is merged/appended with the existing dialog information of the DS 140, integrating the dialog information from the dialog agent N 160 is merged/appended with the existing dialog information of the DS 140 that included the merged/appended dialog information from the integrated dialog agent 1 147 dialog information. In one embodiment, once the DS 140 determines an appropriate reply to a user's utterance, the result is passed to the TTS engine 144 for conversion to speech where the output is sent to the audio output 123 so that the user may hear the reply. In one embodiment, the results are forwarded to the display 121 for users to be able to read the reply.

FIG. 3 shows an example flow chart process 200 for dialog agent integration (e.g., third-party dialog agent(s)) for an electronic device (e.g., electronic device 120), according to an embodiment. In one embodiment, the process 200 starts with block 201 where the process 200 starts up. In one embodiment, the process 200 may begin by a user launching a voice recognition application on a mobile or stationary electronic device (e.g., electronic device 120) using the input mechanism 124 (e.g., tapping on a display screen, pressing a button, using a remote control, launching a dialog application, etc. In one embodiment, speech signals entered through a microphone (e.g., microphone 122) are processed by an ASR (e.g., ASR 135) and input in block 202 for an initial utterance for the process 200.

In one embodiment, in block 203, it is determined whether the DS (e.g., DS 140) includes a dialog agent to handle the inputted utterance already installed/integrated within the dialog information of the DS (e.g., NLU, NLG, and DM information). If it is determined that the dialog agent required to handle the inputted utterance is already installed/integrated in the DS, then process 200 continues to block 209, otherwise process 200 continues to block 204. In one embodiment, in block 204, a DS (e.g., DS 140) automatically checks to determine whether it can locate/discover a dialog agent that can handle the inputted utterance in the appropriate service domain remotely (e.g., on the cloud/network 130, application store, etc.). In another embodiment, a user may use the DS to manually search a remote location to discover a dialog agent that can handle the inputted utterance in the appropriate service domain.

In one embodiment, in block 205, if it is determined that a dialog agent that may handle the user request is found to exist, process 200 continues with block 206, otherwise process 200 continues with block 207. In one embodiment, in block 206 the DS system requests whether the user desires that that the new dialog agent to be installed in the DS. If it is determined that the new dialog agent is desired to be installed, process 200 continues to block 208, otherwise process 200 continues to block 207. In one embodiment, in block 208, the new dialog agent is integrated into the DS, where the NLU, NLG, and DM information from the new agent is merged/added into the existing NLU, NLG and DM information of the DS. Process 200 continues to block 209 where the newly added dialog agent handles the user's dialog services request. In block 210, process 200 then terminates upon completion of the dialog session.

In one embodiment, in block 207, the user is informed of the inability to handle the request for dialog services, and process 200 continues to block 210 where process 200 terminates. In one embodiment, the process 200 may take include other functionality or processing to accomplish the goal of adding new dialog agents. In one embodiment, the process for integrating a new dialog agent comprises registering the new dialog agent with the DS, and adding its dialog functionalities (NLU, NLG, and DM) to the DS in any possible manner.

FIG. 4 shows an example flow chart 300 for dialog agent integration for an electronic device, according to an embodiment. In one embodiment, the process 300 is segmented into a system level portion 310, an ASR engine (e.g., via ASR engine 135) portion 320, and a third-party applications portion 330 including interaction with the DS 140. In one embodiment, the process 300 starts with block 310 where a speech is entered into the microphone 122 and converted into speech signals 312.

In one embodiment, the speech signals 212 enter into the ASR 135 in block 320 and are converted into words. Process 300 continues where the recognized words are entered into a natural language model and grammar module 351 for forming a request that may be understood based on using the NLU information of the appropriate dialog agent determined from within the NLU file(s) (or added as a new dialog agent with process 200). In one embodiment, the new dialog information is retrieved using process 200 from third-party applications 345. Process 300 continues to block 352 where the understood words are progressed through a dialog conversation through the DM structure (e.g., tree structure, any other appropriate structure, etc.), and the natural language response based on the NLG information is returned in block 353. Process 300 continues to block 340 where the natural language responses from the DS 140 are passed to block 340 for determining the specific vocabulary for the ASR 135. In one embodiment, a TTS application (e.g., TTS engine 144) is used to then convert the reply words into speech for output from the audio output (e.g., audio output 123) of an electronic device (e.g., electronic device 120).

FIG. 5 shows an example dialog agent NLU information 400 for dialog agent integration for an electronic device (e.g., electronic device 120, FIG. 1), according to an embodiment. In the NLU information example 400, the contents comprise terms/words appropriate for a hotel/motel room booking or reservation dialog agent in a notation form where a CFG parser detects an utterance based on locating a production rule for a respective dialog agent. In one embodiment, each production rule is associated with a PCFG, wherein probability of each possible parse is used for identifying a most likely interpretation of speech input to the DS 140 from the ASR 135.

In one embodiment, the CFG parser of the DS 140 begins at the left side of the NLU information 400 by analyzing a user's utterance. In one implementation, some words in a production are optional (i.e., denoted using a ‘?’) for adding flexibility to the DS 140 to handle cases where some information may be missing or incorrectly provided by the ASR 135. In one embodiment, if the user's utterance can be parsed using the rule, then the corresponding agent may be able handle the user's dialog request.

FIG. 6 shows an example dialog agent NLU information 400 shown in picture form 600 for dialog agent integration for an electronic device (e.g., electronic device 120, FIG. 1), according to an embodiment. In one example, acceptable input handled by the dialog agent (e.g., the hotel/motel room booking or reservation dialog agent) includes user utterances such as combination of words in the NLU information of, “I want to reserve a room,” “Book one hotel,” “I need to locate an inn.” By providing a CFG grammar such as above, a generic CFG parser may be used to detect a user utterance by locating the main production rule for a respective agent. In this case, if the CFG parser detects the “BookReservation” production rule from a user's input, then the dialog system knows that it should execute a dialog agent, such as a “Simple Hotel Agent.” In one embodiment, if each production has a probability (e.g., a PCFG), then the probability of each possible parse may be used to identify the most likely interpretation of the user's utterance. This may be useful for resolving conflicts when multiple dialog agents can possibly handle a certain user's utterance.

In one embodiment, for NLG information, a dialog agent may simply list possible system responses associated with each of its supported actions. In one example, after the Simple Hotel Agent has been activated, the dialog agent may respond to the user by asking for additional information by sending the following question to the TTS engine 144, “Where are you going?” Other possible system responses: “I found the hotels A, B, and C. Which one would you like?”; “I am sorry, this hotel has no vacancy.”; or “Your reservation is complete. Thank you.”

FIG. 7 shows an example dialog agent structure 700 for DM information (e.g., DM information in DM module 143) for dialog agent integration for an electronic device, (e.g., electronic device 120, FIG. 1), according to an embodiment. In one embodiment, a dialog structure (e.g., a tree structure, any other appropriate structure, etc.) may be provided to gather additional information to implement the DM information to achieve a user's dialog goal. In some embodiments, the implementation of the DM may vary from DS to DS. In one embodiment, the fundamental design of a dialog agent's DM may mirror the structure of a tree. In one implementation, the DM contains a root node, which provides information to the DS about how to progress the conversation once selected for execution. The lowest level of the tree lists actions that may require additional dialog. If more dialog is required, it is up to the agent's DM to provide the additional functionality.

In one example embodiment, the third-party agent “Simple Hotel Agent” 710 is shown as a node with actions 721, 722, and 723 connected below. In one example, action 721 is associated with a book reservation action; action 722 is associated with a cancel reservation action; and action 723 is associated with a check reservation status action. Each of the actions 721, 722, and 723 are nodes for sub-actions 731, 732, and 733. In one example, sub-action 731 may include sub-actions for: ask for destination, ask for date, show user results, and confirm reservation. In one example, sub-action 732 may include sub-actions for: get reservation identification (ID) and confirm cancellation. In one example, sub-action 733 may include sub-actions for: get reservation ID and explain status to user. In one embodiment, each of the actions and sub-actions shown in DM information 700 are associated with possible replies that are maintained in the NLG information.

In this example, the Simple Hotel Agent 710 may book, cancel, and check the status of hotel reservations. When trying to book a reservation, additional detail is required to complete this task. The DM module 143 determines where the user wants to go and when the user wants to make the reservation. In one embodiment, the additional dialog required to ask the user is obtained from NLG templates, and the NLU information is obtained from additional grammar. It should be noted that the dialog agent structure 700 only includes the dialog structure (e.g., tree structure, any other appropriate structure, etc.) of a single agent, but in one embodiment the DS 140 may include multiple sub-structures that add additional functionality to the system.

FIG. 8 shows an example existing dialog agent structure 800 for dialog agent integration for an electronic device (e.g., electronic device 120), according to an embodiment. In one embodiment, the user utterance 312 would be used for traversing the structure 800 starting with the root node 810. In one implementation, the first level contains the main actions of the dialog agent. In one embodiment, the leaves of this tree structure are sub-actions that are required to accomplish a main action.

In one embodiment, the structure 800 shows the DM information (e.g., from the DM module 143, FIG. 2) for the existing DM information that includes dialog agent 821 (Greeting Agent), dialog agent 822 (Photo Agent) and dialog agent 823 (Calendar Agent). In one example, the dialog agent 821 includes the actions 831, such as “Welcome” and “Update User.” In one example, the dialog agent 822 includes the actions 832, such as “Take User's Photo” and “Simple Photo Edit.” In one example, the dialog agent 823 includes the actions 833, such as “Set Event” and “Cancel Event.”

FIG. 9 shows an example of an expanded NLU information 900 for an integrated dialog agent for an electronic device (e.g., electronic device 120, FIG. 1), according to an embodiment. In one embodiment, the expanded NLU information 900 includes: NLU information 921 for a greeting dialog agent; NLU information 922 for a simple photo editing dialog agent; NLU information 923 for a calendar dialog agent; and NLU information 924 for a motel/hotel booking dialog agent. In one embodiment, the added additional grammar for the DS is provided in order to understand the user's utterances. The grammar file now contains four grammar rules, which can be used by any compatible CFG parser to determine which dialog agent should be invoked.

In one embodiment, the existing NLU information initially comprised of dialog agents 921, 922, and 923, and then had the NLU information 924 merged/added to the existing NLU information to result in the NLU information 900. In one example, the Greeting Agent may respond to user's greetings and update the user about information about the DS. The Photo Agent may use a built-in camera device to take pictures and make simple photo edits. The Calendar Agent may set and cancel events in the user's calendar. In one implementation, the example dialog agents comprise grammar and responses associated with each of their actions. Each action may require sub-dialogues that the dialog agent's DM will be able to handle.

FIG. 10 shows an example of the expanded NLU information 900 shown in picture form 1000 for an integrated dialog agent for an electronic device (e.g., electronic device 120, FIG. 1), according to an embodiment. In one embodiment, the expanded NLU information shown in picture form 1000 includes: NLU information 1021 for a greeting dialog agent; NLU information 1022 for a simple photo editing dialog agent; NLU information 1023 for a calendar dialog agent; and NLU information 1024 for a motel/hotel booking dialog agent.

FIG. 11 shows an example expanded dialog agent structure 1100 for an integrated dialog agent for an electronic device (e.g., electronic device 120, FIG. 1), according to an embodiment. In one embodiment, for the DM information, since the DMs are represented as structures (e.g., trees, any other appropriate structure, etc.), the integration requires adding another branch to the DS. In one implementation, after adding another branch to the DS, a user may ask any utterance that is understood by any of the sub-structures (e.g., sub-trees, any other appropriate sub-structures, etc.). In one example, if a user were to say, “I would like to edit a photo,” this utterance would start at the root of the dialog structure (e.g., tree, any other appropriate structure, etc.). In one example, the NLU module would parse the user's utterance and determine that the production rule belonging to the Photo Agent matches the utterance. In one example, in the dialog structure (e.g., tree, any other appropriate structure, etc.), the Photo Agent's “Simple Photo Edit” action would execute. After the completion of this action, the user may then say another request, such as “I need a motel.” In one example, since the Simple Hotel Agent has been integrated with the DS, the utterance may be matched with the “Book Reservation” rule, and the Simple Hotel Agent would execute the corresponding “Book Reservation” action. If the user did not have the Simple Hotel Agent, the DS would be unable to understand the utterance since the dialog specific functionality for this service domain would be missing.

In one embodiment, the existing DM information in the dialog agent structure 1100 comprised dialog agent structure 800. After the dialog agent Simple Hotel Agent 1124 is merged/added, the resulting dialog agent structure 1100 includes the dialog agents 821, 822, 823 and 1124. In one example, the actions 1134 for the added dialog agent 1124 include: Book Reservation; Cancel Reservation; and Check Reservation Status.

FIG. 12 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation in a mobile wireless device such as a mobile phone, the system 500 further includes an image capture device such as a camera 15. The system 500 may further include application modules as MMS module 521, SMS module 522, email module 523, social network interface (SNI) module 524, audio/video (AV) player 525, web browser 526, image capture module 527, etc.

The system 500 further includes a discovery module 11 as described herein, according to an embodiment. In one implementation of dialog agent integration processes 530 along with an operating system 529 may be implemented as executable code residing in a memory of the system 500. In another embodiment, such modules are in firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

The embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for dialog agent integration, comprising:
discovering a dialog agent required for a dialog request, the dialog agent including dialog information comprising terms required for audio speech feedback in a service domain required for the dialog request;
extracting the dialog information from the discovered dialog agent;
integrating the dialog information to existing dialog information of a dialog system (DS) that provides dialog speech functionality for an electronic device; and
expanding service domain dialog functionality of the DS with the integrated dialog information.

2. The method of claim 1, wherein the existing dialog information comprises natural language understanding (NLU) information, natural language generation (NLG) information, and dialog manager (DM) information for one or more existing service domains.

3. The method of claim 2, wherein the dialog information of the dialog agent comprises NLU information, NLG information, and DM information for the service domain required for the dialog request.

4. The method of claim 3, wherein the expanded dialog functionality comprises the one or more existing service domains and the service domain required for the dialog request.

5. The method of claim 4, wherein NLU information comprises context-free grammar (CFG) provided in a notation form.

6. The method of claim 5, wherein a CFG parser detects an utterance based on locating a production rule for a respective dialog agent.

7. The method of claim 6, wherein each production rule is associated with a probabilistic CFG (PCFG), wherein probability of each possible parse is used for identifying a most likely interpretation of speech input to the DS from an automatic speech recognition (ASR) engine.

8. The method of claim 5, wherein NLG information comprises a list of possible grammatical feedback responses associated with supported actions, and the DM information comprises an ordered structure for progressing through a dialog conversation once selected for execution.

9. The method of claim 8, wherein the ordered structure comprises a dialog tree including nodes representing user requested actions and branches connected to the nodes representing speech responses.

10. The method of claim 8, wherein integrating the dialog information of the dialog agent to the existing dialog information of the DS comprises:
adding the NLU information from the dialog agent to the NLU information of the existing dialog information;
adding the NLG information from the dialog agent to the NLG information of the existing dialog information; and
adding the DM information from the dialog agent to the DM information of the existing dialog information.

11. The method of claim 2, wherein the electronic device comprises a mobile phone, and the dialog agent is provided over a network.

12. A system for dialog agent integration, comprising:
an electronic device including a microphone for receiving speech signals and an automatic speech recognition (ASR) engine that converts the speech signals into words; and
a dialog system (DS) that receives the words from the ASR engine and provides dialog functionality for the electronic device, the dialog system comprising a DS agent interface that integrates dialog information from a dialog agent to existing dialog information of the DS for expanding service domain dialog functionality of the DS.

13. The system of claim 12, wherein the existing dialog information of the DS comprises natural language understanding (NLU) information, natural language generation (NLG) information, and dialog manager (DM) information for one or more existing service domains, and the dialog information of the dialog agent comprises NLU information, NLG information, and DM information for a particular service domain of the dialog agent.

14. The system of claim 13, wherein the expanded dialog functionality comprises the one or more existing service domains and the service domain of the dialog agent.

15. The system of claim 13, wherein NLU information comprises context-free grammar (CFG) provided in a notation form, and the DS further comprises a CFG parser that detects a request based on the words by locating a production rule for a respective domain.

16. The system of claim 15, wherein each production rule is associated with a probabilistic CFG (PCFG), wherein probability of each possible parse by the CFG parser is used for identifying a most likely interpretation of the words input to the DS from the ASR engine.

17. The system of claim 16, wherein NLG information comprises a list of possible grammatical feedback responses associated with supported actions, and the DM information comprises an ordered structure for progressing through a dialog conversation once selected for execution.

18. The system of claim 17, wherein the ordered structure comprises a dialog tree including nodes representing user requested actions and branches connected to the nodes representing speech responses.

19. The system of claim 17, wherein the DS agent interface integrates dialog information from the dialog agent to the existing dialog information of the DS based on:
adding the NLU information from the dialog agent to the NLU information of the existing dialog information;
adding the NLG information from the dialog agent to the NLG information of the existing dialog information; and
adding the DM information from the dialog agent to the DM information of the existing dialog information.

20. The system of claim 19, wherein the electronic device comprises a mobile phone, and the dialog agent is provided over a network.

21. A non-transitory computer-readable medium having instructions which when executed on a computer perform a method comprising:
discovering a dialog agent required for a dialog request, the dialog agent including dialog information comprising feedback terms required for audio feedback in a service domain required for the dialog request;
extracting the dialog information from the discovered dialog agent;
integrating the dialog information to existing dialog information of a dialog system (DS) that provides dialog functionality for of an electronic device; and
expanding service domain dialog functionality of the DS with the integrated dialog information.

22. The medium of claim 21, wherein the existing dialog information of the DS comprises natural language understanding (NLU) information, natural language generation (NLG) information, and dialog manager (DM) information for one or more existing service domains, and the dialog information of the dialog agent comprises NLU information, NLG information, and DM information for a particular service domain of the dialog agent.

23. The medium of claim 22, wherein the expanded dialog functionality comprises one or more existing service domains and the service domain required for the dialog request.

24. The medium of claim 23, wherein NLU information comprises context-free grammar (CFG) provided in a notation form, and the DS further comprises a CFG parser that detects a request based on the words by locating a production rule for a respective service domain.

25. The medium of claim 24, wherein each production rule is associated with a probabilistic CFG (PCFG), wherein probability of each possible parse is used for identifying a most likely interpretation of speech input to the DS from an automatic speech recognition (ASR) engine of the electronic device.

26. The medium of claim 24, wherein NLG information comprises a list of possible grammatical feedback responses associated with supported actions, and the DM information comprises an ordered structure for progressing through a dialog conversation once selected for execution.

27. The medium of claim 26, wherein the ordered structure comprises a dialog tree including nodes representing user requested actions and branches connected to the nodes representing speech responses.

28. The medium of claim 26, wherein integrating the dialog information of the dialog agent to the existing dialog information of the DS comprises:
adding the NLU information from the dialog agent to the NLU information of the existing dialog information;
adding the NLG information from the dialog agent to the NLG information of the existing dialog information; and
adding the DM information from the dialog agent to the DM information of the existing dialog information.

29. The medium of claim 28, wherein the electronic device comprises a mobile phone, and the dialog agent is provided over a network.
